(19) United States
(12) Patent Application Publication
(10) Pub. No.: US 2025/0159694 A1
(43) Pub. Date: May 15, 2025

(54) SLOT FORMAT CONFIGURATION FOR SMART NODES

(71) Applicant: ZTE CORPORATION, Shenzhen (CN)

(72) Inventors: Hanqing XU, Shenzhen (CN); Nan ZHANG, Shenzhen (CN); Ziyang LI, Shenzhen (CN); Wei CAO, Shenzhen (CN)

(73) Assignee: ZTE CORPORATION, Shenzhen (CN)

(21) Appl. No.: 19/020,631

(22) Filed: Jan. 14, 2025

Related U.S. Application Data
(63) Continuation of application No. PCT/CN2022/106055, filed on Jul. 15, 2022.

(51) Int. Cl. H04W 72/231

(52) U.S. Cl. CPC H04W 72/231

(57) ABSTRACT

The present disclosure is directed to slot format configuration for smart nodes, including receiving, by a network node from a wireless communication node, configuration information indicating a type of a number of first symbols in a slot, the type includes at least one of: a downlink symbol, an uplink symbol, or a special symbol.

### CROSS-REFERENCE TO RELATED APPLICATION

This application claims the benefit of priority under 35 U.S.C. § 120 as a continuation of PCT Patent Application No. PCT/CN2022/106055, filed on Jul. 15, 2022, the disclosure of which is incorporated herein by reference in its entirety.

### TECHNICAL FIELD

The disclosure relates generally to wireless communications and, more particularly, to systems, methods, and non-transitory computer-readable media for slot format configuration for smart nodes.

### BACKGROUND

Coverage is a fundamental aspect of cellular network deployments. Mobile operators rely on blanket coverage to deliver reliable cellular network deployments. Therefore, new types of network nodes are desired to increase mobile operators' flexibility for their network deployments.

### SUMMARY

The example arrangements relate to slot format configuration for smart nodes. A wireless communication method can include receiving, by a network node from a wireless communication node, configuration information indicating a type of a number of first symbols in a slot, where the type includes at least one of a downlink symbol, an uplink symbol, or a special symbol.

The special symbol can cause the network node to perform one or more of optionally forwarding based on the special symbol, sensing based on the special symbol, switching between DL and UL based on the special symbol, beam switching based on the special symbol, switching between ON and OFF states based on the special symbol, and be turned OFF based on the special symbol.

The method can include receiving, by the network node, the configuration information from the wireless communication node through a signaling, where the signaling includes at least one of system information, a Radio Resource Control (RRC) signaling, a medium access control control element (MAC CE) signaling, or a Downlink Control Information (DCI) signaling.

For example, the configuration information does not indicate a type of a number of second symbols in the slot as the downlink symbol or the uplink symbol.

The method can include determining, by the network node, the type of the second symbols as the special symbol. The method can include determining, by the network node, the type of the second symbols as a flexible symbol.

For example, the type of some or all of the second symbols is configured as the special symbol. For example, the type of all of the second symbols is the special symbol. For example, the type of some of the second symbols is configured as the special symbol, and the type of some of the second symbols is configured as one of the downlink symbol, the uplink symbol, an ON state, or an OFF state. For example, the type of some of the second symbols is configured as the special symbol, and the type of one or more remaining ones of the second symbols is the downlink symbol or the uplink symbol by default. For example, the configuration information indicates a type of each symbol in the slot as one of the downlink symbol, the uplink symbol, or the special symbol. For example, the configuration information does not indicate a type of a number of second symbols in the slot as the downlink symbol, the uplink symbol, or the special symbol.

The method can include determining, by the network node, the type of the second symbols as a flexible symbol. The method can include determining, by the network node, the type of the second symbols as either the downlink symbol or the uplink symbol.

For example, the configuration information indicates the type of the first symbols in the slot as the special symbol and indicates that the second symbols are before the first symbols, and the method can include determining, by the network node, the type of the second symbols as the downlink symbol. For example, configuration information indicates the type of the first symbols in the slot as the special symbol and indicates that the second symbols are after the first symbols, and the method can include determining, by the network node, the type of the second symbols as the uplink symbol. For example, the configuration information indicates the type of the first symbols in the slot as the special symbol and indicates that the second symbols are before the first symbols, and the method can include determining, by the network node, the type of the second symbols as the uplink symbol. For example, configuration information indicates the type of the first symbols in the slot as the special symbol and indicates that the second symbols are after the first symbols, and the method can include determining, by the network node, the type of the second symbols as the downlink symbol. For example, the configuration information indicates the type of the first symbols in the slot as the special symbol and indicates that the second symbols are before the first symbols, and the method can include determining, by the network node, the type of the second symbols as a same type as one of the first symbols nearest to the second symbols. For example, the configuration information indicates the type of the first symbols in the slot as the special symbol and indicates that the second symbols are after the first symbols, and the method can include determining, by the network node, that the type of the second symbols as a same type as one of the first symbols nearest to the second symbols.

The method can include determining, by the network node in the second symbols, that the network node is turned off, a forwarding unit of the network node is turned off, or the forwarding link is turned off.

The method can include receiving, by the network node through a signaling from the wireless communication node, a message indicating the type of second symbols as the downlink symbol, the uplink symbol, or an ON/OFF state, where the signaling includes at least one of system information, a Radio Resource Control (RRC) signaling, a medium access control control element (MAC CE) signaling, or a Downlink Control Information (DCI) signaling.

The method can include receiving, by the network node through a first signaling from the wireless communication node, a first configuration that indicates the type of first symbols as the downlink symbol, the uplink symbol, or a flexible symbol, and receiving, by the network node through a second signaling from the wireless communication node, a second configuration that reconfigures the type of first symbols as the special symbol, where the first signaling includes at least one of system information, a Radio Resource Control (RRC) signaling, a medium access control control element (MAC CE) signaling, or a Downlink Control Information (DCI) signaling, and where the second signaling includes at least one of a Radio Resource Control (RRC) signaling, a medium access control control element (MAC CE) signaling, or a Downlink Control Information (DCI) signaling.

For example, the second configuration configures at least one of the following information an index of the slot, a periodicity, a reference sub-carrier spacing, indication of a type of all symbols in the slot as the special symbol, an index of a starting one of the first symbols, a length of the first symbols, a bitmap, an index corresponding to a slot format can include the first symbols, or a function of the first symbols.

A wireless communication apparatus can include at least one processor and a memory, where the at least one processor is configured to read code from the memory and implement a method. A computer program product can include a computer-readable program medium code stored thereupon, the code, when executed by at least one processor, causing the at least one processor to implement a method.

The above and other aspects and their arrangements are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication network, and/or system, in which techniques disclosed herein may be implemented, in accordance with some arrangements.

FIG. 2 illustrates a block diagram of an example wireless communication system for transmitting and receiving wireless communication signals in accordance with some arrangements.

FIG. 3 illustrates a block diagram of an example smart node architecture in accordance with some arrangements.

FIG. 4 illustrates a block diagram of an example time-division duplex (TDD) configuration in accordance with some arrangements.

FIG. 5 illustrates a block diagram of an example TDD configuration in accordance with some arrangements.

FIG. 6 illustrates a block diagram of an example TDD configuration in accordance with some arrangements.

FIG. 7 illustrates a block diagram of an example TDD configuration in accordance with some arrangements.

FIG. 8 illustrates a block diagram of an example TDD configuration in accordance with some arrangements.

FIG. 9 illustrates a block diagram of an example TDD configuration in accordance with some arrangements.

FIG. 10 illustrates a block diagram of an example TDD configuration in accordance with some arrangements.

FIG. 11 is a diagram illustrating an example method for slot format configuration for smart nodes in accordance with some arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

For example, Integrated Access and Backhaul (IAB) can relate to a network node not requiring a wired backhaul. Another type of network node is the RF repeater which simply amplify-and-forward any signal that it receive. RF repeaters can include a wide range of deployments in 2G, 3G and 4G to supplement the coverage provided by regular full-stack cells. RF repeater only has radio unit.

A network-controlled repeater can enhance RF repeaters with the capability to receive and process side control information from the network. Side control information could allow a network-controlled repeater to perform its amplify-and-forward operation in a more efficient manner. Potential benefits include mitigation of unnecessary noise amplification, transmissions and receptions with better spatial directivity, and simplified network integration. A network-controlled repeater can be regarded as a stepping stone of re-configurable intelligent surface (RIS), a RIS node can adjust the phase and amplitude of received signal to improve the coverage.

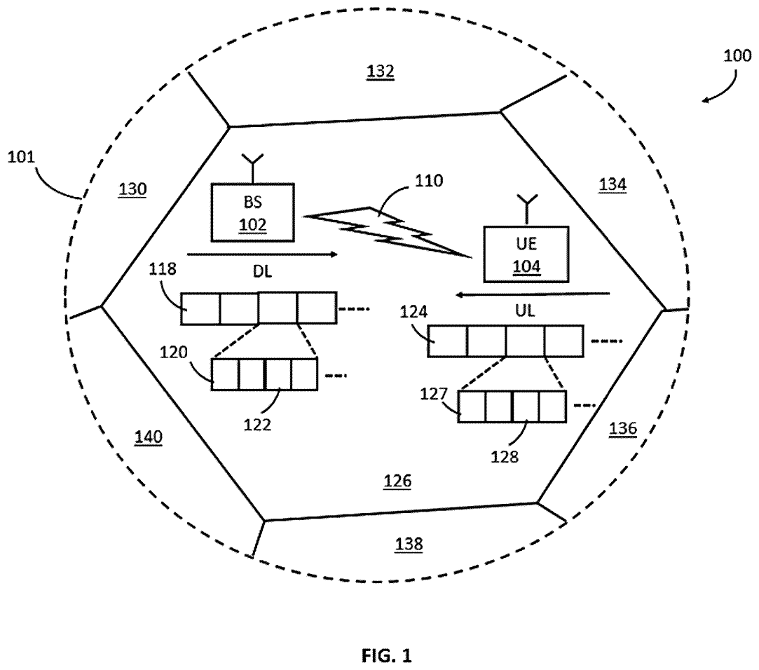

FIG. 1 illustrates an example wireless communication network, and/or system, 100 in which techniques disclosed herein may be implemented, in accordance with an arrangement of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (also referred to as wireless communication node) and a UE device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the base station 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the base station 102 and UE 104 are described herein as non-limiting examples of “communication nodes,” generally, which can practice the methods disclosed herein. Such communication nodes may be capable of wireless and/or wired communications, in accordance with various arrangements of the present solution.

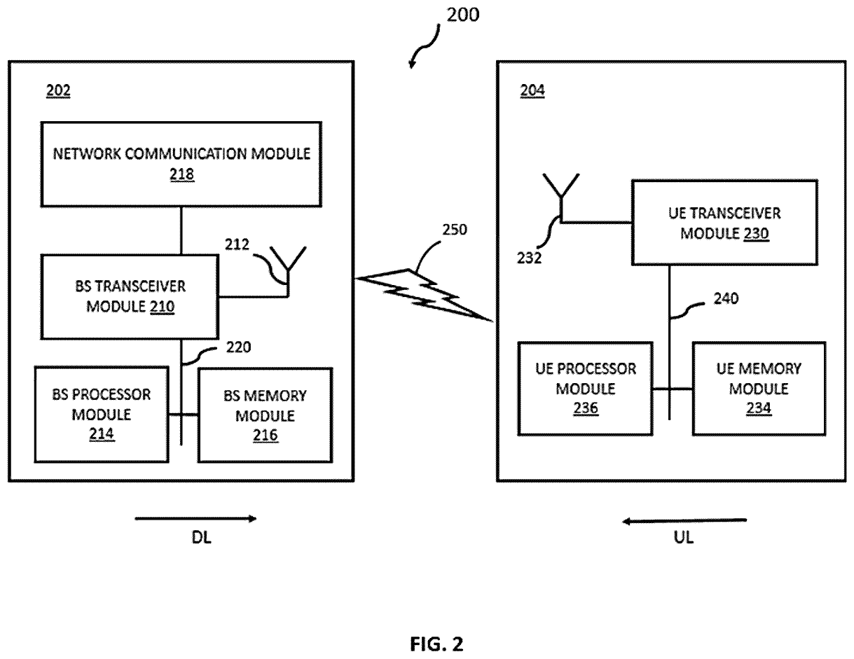

FIG. 2 illustrates a block diagram of an example wireless communication system 200 for transmitting and receiving wireless communication signals (e.g., OFDM/OFDMA signals) in accordance with some arrangements of the present disclosure. The system 200 may include components and elements configured to support known or conventional operating features that need not be described in detail herein. In one illustrative arrangement, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an evolved node B (eNB), gNB, a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

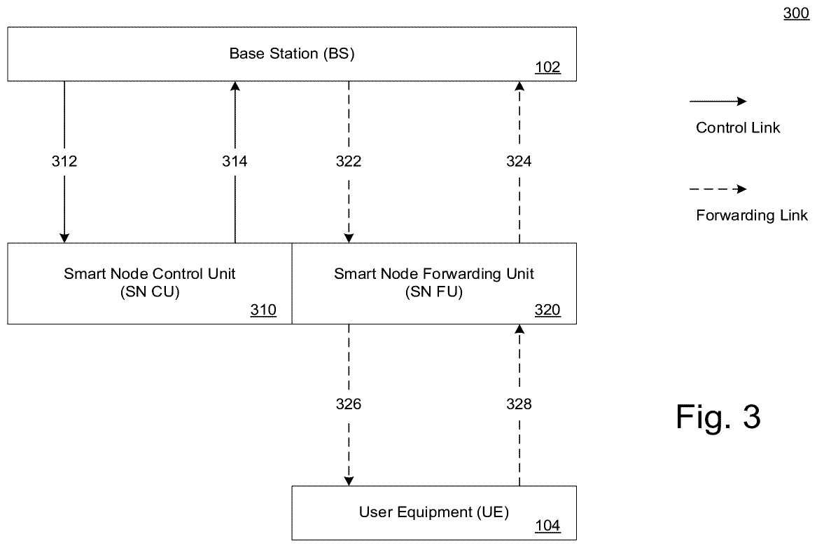

FIG. 3 illustrates a block diagram of an example smart node architecture in accordance with some arrangements. As illustrated by way of example in FIG. 3, an example smart node architecture 300 can include the base station 102, the user equipment 104, and a smart node control unit (SN CU) 310, a smart node forwarding unit (SN FU) 320. The SN CU 310 can receive control signal 312 from the BS 102, and can transmit control signal 314 to the BS 102. The SN FU 320 can receive forwarding signal 322 from the BS 102, and can transmit forwarding signal 324 to the BS 102. The SN FU 320 can transmit forwarding signal 326 to the UE 104, and can receive forwarding signal 328 to the BS 102.

The SN can include, for example, two units to support different functions: a first unit and a second unit respectively. Among them, the first unit acts like a UE to receive and decode side control information from the BS. The first unit can correspond to a control unit or communication unit (CU), mobile termination (MT), part of UE, third-party IoT device and so on. The second unit carries out intelligent amplify-and-forward operation using the side control information received by the first unit of the SN. So it can also be called forwarding unit (FU), radio unit (RU), RIS and so on. For example, CU and FU can refer to the first unit and the second unit of the SN respectively.

A control link can include a signal from one side will be detected and decoded by the other side, so that the information transmitted in the control link can be utilized to control the status of forwarding links. A forwarding link can include a signal from BS or UE that is unknown by SN FU. The SN FU can amplify and forward signals without decoding them. The forwarding links 322 and 326 can comprise a complete DL forwarding link from BS to UE, in which forwarding link 326 is the SN FU DL forwarding link. The forwarding links 324 and 328 can comprise a complete UL forwarding link from UE to BS, in which the forwarding link 324 is the SN FU UL forwarding link. The forwarding links 322 and 324 can be backhaul links, and the forwarding links 326 and 328 can be access links.

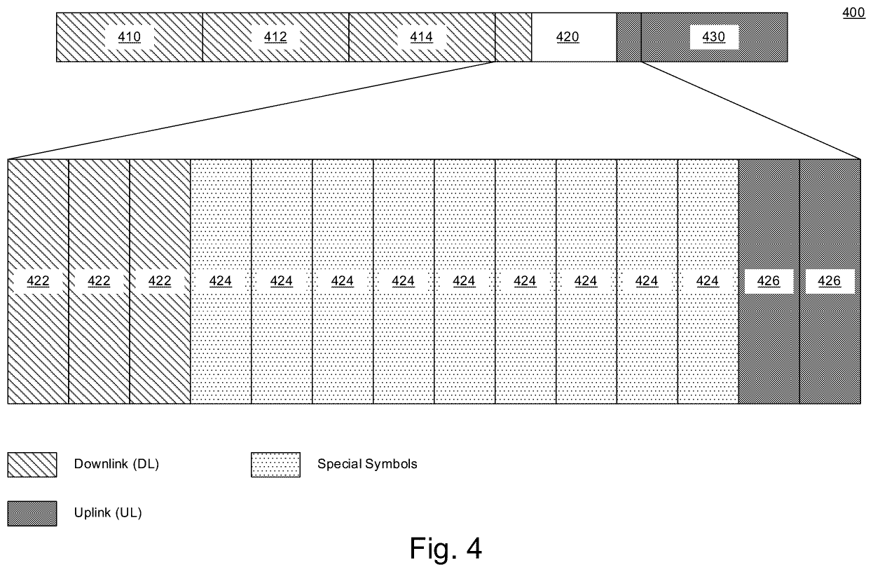

FIG. 4 illustrates a block diagram of an example time-division duplex (TDD) configuration in accordance with some arrangements. As illustrated by way of example in FIG. 4, an example TDD configuration 400 can include downlink slots 410, 412 and 414, slot 420, and uplink slot 430. The slot 420 can include downlink symbols 422, special symbols 424, and uplink symbols 426.

Type or direction of a symbol or a slot can be configured as downlink (DL), uplink (UL) or flexible (DL or UL) via semi-static or dynamic TDD UL/DL configuration. Flexible symbols can be symbols other than uplink symbols or downlink symbols which are explicitly configured via above configuration. However, for the SN, flexible symbols can cause uncertainty about the behavior of the SN. If the direction or behavior of flexible symbols is not further clarified, the SN does not know whether it should forward uplink transmission to the BS, downlink transmission to the UE, or shutdown the SN FU. The SN may even assume this is an error case.

Some arrangements are directed to a new type of symbols in a slot format. In order to solve ambiguity, some arrangements include a new type of symbols in the slot format other than DL/UL/flexible as an “special symbol.” If all symbols in a slot are of this special symbol type, the slot can be an “special slot”. The configuration method of “special symbols” given in this disclosure can also be applicable to an “special slot.” Special symbols can include symbols in which the SN forwarding is not required. That is, the SN does not need to forward the transmission from the base station/UE to the UE/base station in the special symbols. E.g., the SN does not perform links 322 or links 324, or the SN does not perform links 326 or links 328. That is, the SN does not perform backhaul links or access links.

In special symbols, SN can perform at least one of various operations. SN forwarding can be optional or absent in special symbols. For example, the SN does not need to amplify and/or forward the transmission from the base station/UE to the UE/base station in the special symbols. The SN can be turned off in special symbols. For example, one or more SN FU forwarding links 322, 324, 326 and 328, backhaul links and/or access links can be turned off in special symbols. The SN can perform the switching between DL and UL. The SN can perform beam switching. The SN can perform the switching between ON and OFF. The SN (e.g. SN CU) can perform sensing in special symbols. Sensing can include at least one of the following operation: energy sensing, signal detection, LBT or measurement.

The minimum number of special symbols can be a capability of the SN. The SN can report the minimum number of special symbols or above SN capability to the base station. When the base station configures special symbols for the SN, it needs to be based on the minimum number of special symbols or the SN capability. For example, the number of special symbols configured for the SN needs to be equal to or greater than the minimum number of special symbols or the SN capability.

Special symbols can also correspond to one or more of “un-forward”, “un-amplify-and-forward”, “un-transmit/receive”, “un-relay”, “un-work”, “switching”, “turn on/off”, “sensing”, “LBT” and “measurement” symbols and so on. Some arrangements are directed to configuration of special symbols. The configuration of special symbols can include at least one of various options. These options can be performed independently or in combination, for example.

Except for the symbols configured as downlink or uplink symbols via first TDD configuration carried by system information, RRC signaling, MAC CE and/or DCI signaling, the remaining symbols can be special symbols. The first TDD configuration can be indicated by the BS to SN (e.g. SN CU). This configuration can indirectly configure special symbols. All the symbols that are not explicitly configured as downlink or uplink symbols can be special symbols. Note that the configurations may correspond at least to a configuration parameter or a combination of multiple configuration parameters.

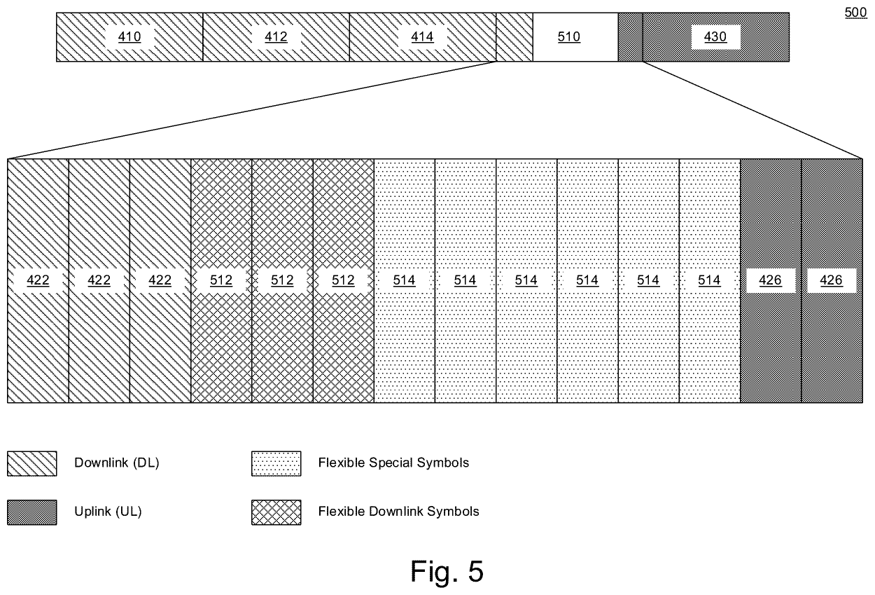

FIG. 5 illustrates a block diagram of an example TDD configuration in accordance with some arrangements. As illustrated by way of example in FIG. 5, an example TDD configuration 500 can include the downlink slots 410, 412 and 414, the uplink slot 430, and slot 510. The slot 510 can include the downlink symbols 422, the uplink symbols 426, flexible downlink symbols 512, and flexible special symbols 514.

Except for the symbols already configured as downlink or uplink symbols via first TDD configuration carried by system information, RRC signaling, MAC CE and/or DCI signaling, the remaining symbols can be flexible symbols. The first TDD configuration can be indicated by the BS to SN (e.g. SN CU). For the flexible symbols, some or all of the flexible symbols can be further configured as special symbols via second TDD configuration, including at least one of the following options. For example, all of the flexible symbols are configured or defined as special symbols. For example, some of the flexible symbols are configured as special symbols. For example, some of the flexible symbols are configured as special symbols, and some of the flexible symbols are further configured as downlink, or uplink, or ON state, or OFF state. For example, some of the flexible symbols is configured as special symbols. The remaining flexible symbols are defined with a default direction (e.g. DL or UL), or the remaining flexible symbols before and after the flexible symbol are respectively defined as downlink and uplink symbols, or uplink and downlink symbols, or defined as ON/OFF state. In this case, the SN does not expect a symbol that is already configured as a DL or as a UL symbol is re-configured as a special symbol.

Preferably, in order to completely eliminate ambiguity caused by flexible symbols, all flexible symbols should be configured as special symbols, or DL/UL symbols, or ON/OFF state symbols. As shown in Figure below, there are a total of X flexible symbols. Wherein, X1 flexible symbols can be configured as DL symbols, and X2 flexible symbols can be configured as special symbols. X1+X2=X. The second TDD configuration of special symbols and/or other types of symbols can be indicated by the BS to the SN (e.g. SN CU) CU and used to control SN FU (or forwarding links) or perform other operations e.g. sensing or switching. The second TDD configuration of special symbols indicated by the BS can be carried by system information (e.g. in SIB1), RRC signaling (e.g. in ServingCellConfigCommon or ServingCellConfig), MAC CE and/or DCI signaling (e.g. DCI format 2_0). Further, if indicated by DCI signaling, it can be scrambled by a new SN specific, link specific, service-type specific, or SN logic unit specific RNTI.

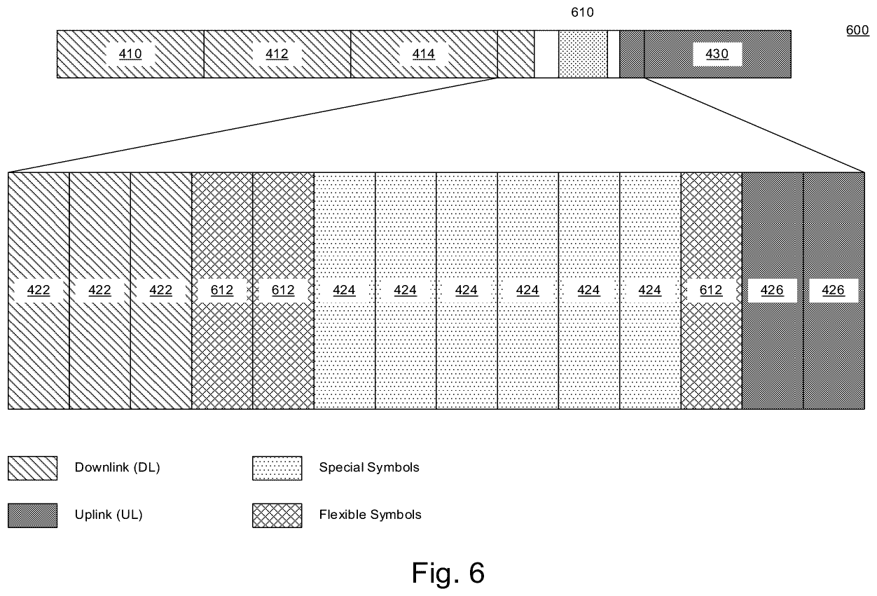

FIG. 6 illustrates a block diagram of an example TDD configuration in accordance with some arrangements. As illustrated by way of example in FIG. 6, an example TDD configuration 600 can include the downlink slots 410, 412 and 414, the uplink slot 430, and slot 610. The slot 610 can include the downlink symbols 422, the special symbols 424, the uplink symbols 426, and flexible symbols 612.

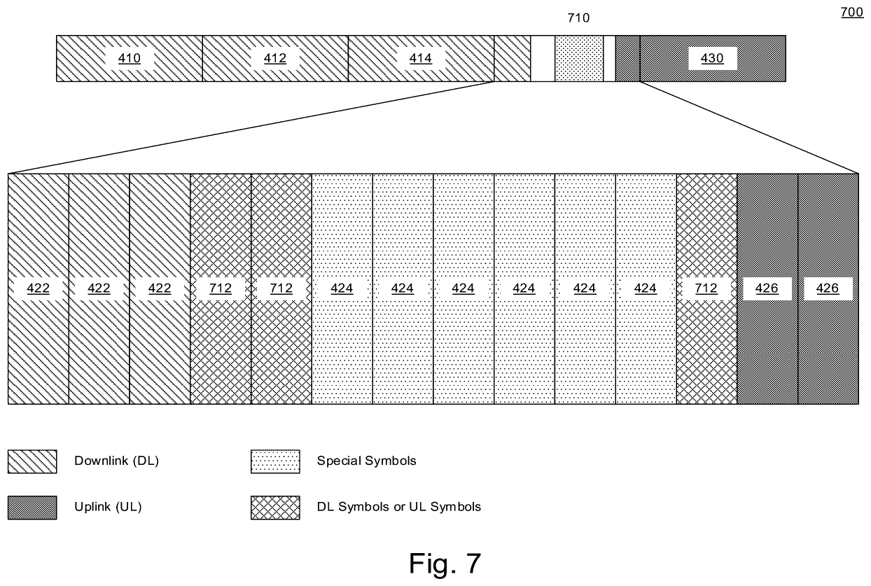

The symbols in a slot can be configured as DL, UL or special symbols via third TDD configuration. The third TDD configuration of DL, UL and special symbols indicated by the BS to the SN (e.g. SN CU) can be carried by system information (e.g. in SIB1), RRC signaling (e.g. in ServingCellConfigCommon or ServingCellConfig), MAC CE and/or DCI signaling (e.g. DCI format 2_0). Further, if indicated by DCI signaling, it can be scrambled by a new SN specific, link specific, service-type specific, or SN logic unit specific RNTI. For example, all symbols in third TDD configuration that is indicated by the BS to the SN can be configured as DL, UL or special symbols. Here, no symbols are not configured as one of above three types. For example, the symbols in third TDD configuration that is indicated by the BS to the SN are configured as DL, UL or special symbols. There are one or more remaining symbols in the configuration that are not configured as one of above three types. For the remaining symbols that are not configured with above three types, at least one of various actions can be performed. For example, the remaining symbols can be flexible symbols. For example, the remaining symbols can be defined with a default direction, such as DL or UL, as illustrated by way of example in FIG. 7.

FIG. 7 illustrates a block diagram of an example TDD configuration in accordance with some arrangements. As illustrated by way of example in FIG. 7, an example TDD configuration 700 can include the downlink slots 410, 412 and 414, the uplink slot 430, and slot 710. The slot 710 can include the downlink symbols 422, the special symbols 424, the uplink symbols 426, and symbols 712 that can include one or more of downlink symbols and uplink symbols.

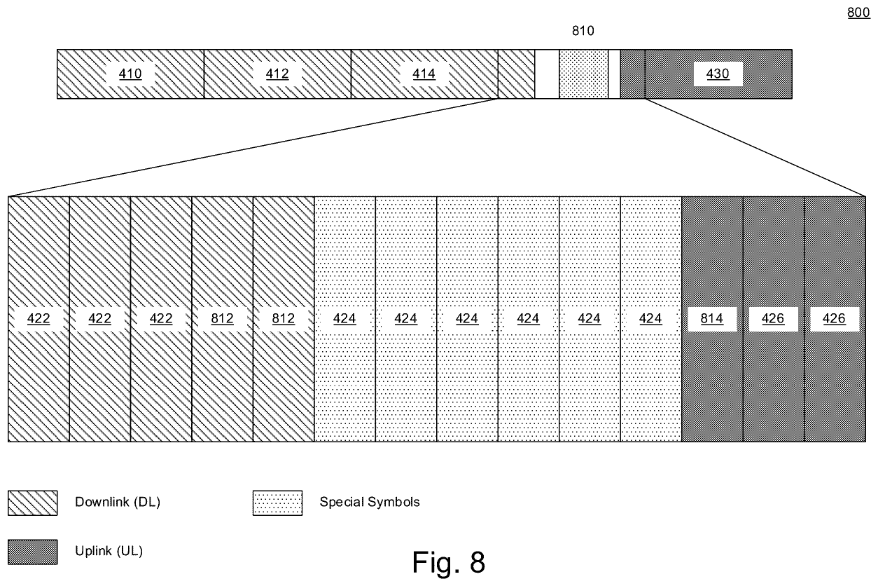

FIG. 8 illustrates a block diagram of an example TDD configuration in accordance with some arrangements. As illustrated by way of example in FIG. 8, an example TDD configuration 800 can include the downlink slots 410, 412 and 414, the uplink slot 430, and slot 810. The slot 810 can include the downlink symbols 422, the special symbols 424, the uplink symbols 426, downlink symbols 812, and uplink symbol 814. For example, the remaining symbols before and after the flexible symbol are respectively defined with downlink and uplink, or uplink and downlink. For example, among the remaining symbols, the remaining symbols before special symbols are DL symbols, and the remaining symbols after special symbols are UL symbols. For example, among the remaining symbols, the remaining symbols before special symbols are UL symbols, and the remaining symbols after special symbols are DL symbols.

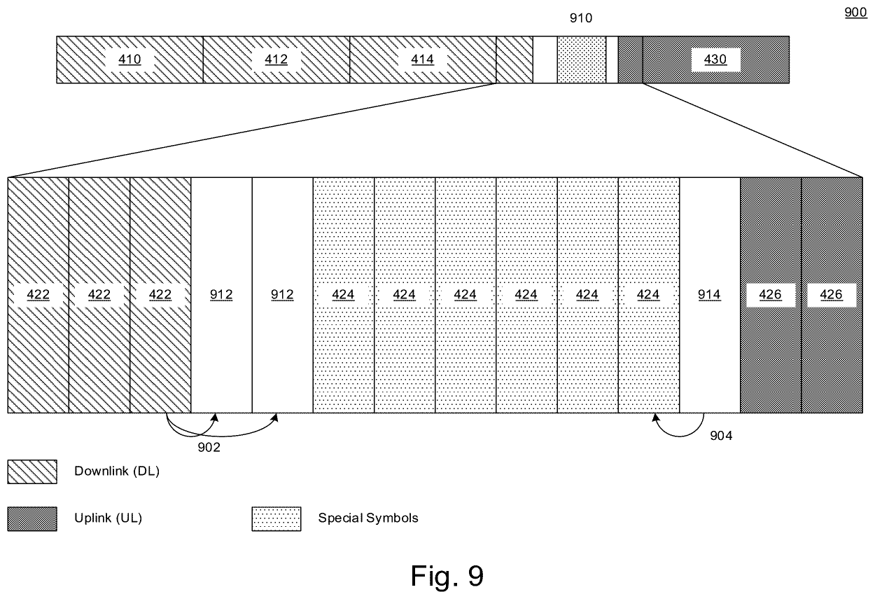

FIG. 9 illustrates a block diagram of an example TDD configuration in accordance with some arrangements. As illustrated by way of example in FIG. 9, an example TDD configuration 900 can include the downlink slots 410, 412 and 414, the uplink slot 430, symbol configuration traces 902 and 904, and slot 910. The slot 210 can include the downlink symbols 422, the special symbols 424, the uplink symbols 426, configured symbols 212, and configured symbol 914. The configured symbols 912 can be configured based on the symbol configuration traces 902 indicating a configuration corresponding to the downlink symbols 422. The configured symbol 914 can be configured based on the symbol configuration trace 904 indicating a configuration corresponding to the uplink symbols 426.

For example, among the remaining symbols, the type (DL or UL) of the remaining symbols before special symbols is the same as that of the nearest symbols configured as DL/UL before special symbols; The type (DL or UL) of the remaining symbols after special symbols is the same as that of the nearest symbols configured as DL/UL after special symbols. For example, the SN can be turned off in remaining symbols; Or, SN FU or forwarding link is turned off in remaining symbols. For example, the types of the remaining symbols can be further indicated as DL, UL, or ON/OFF state via fourth TDD configuration carried by RRC signaling (e.g. in ServingCellConfigCommon or ServingCellConfig), MAC CE and/or DCI signaling (e.g. DCI format 2_0). The fourth TDD configuration can be indicated by the BS to SN (e.g. SN CU).

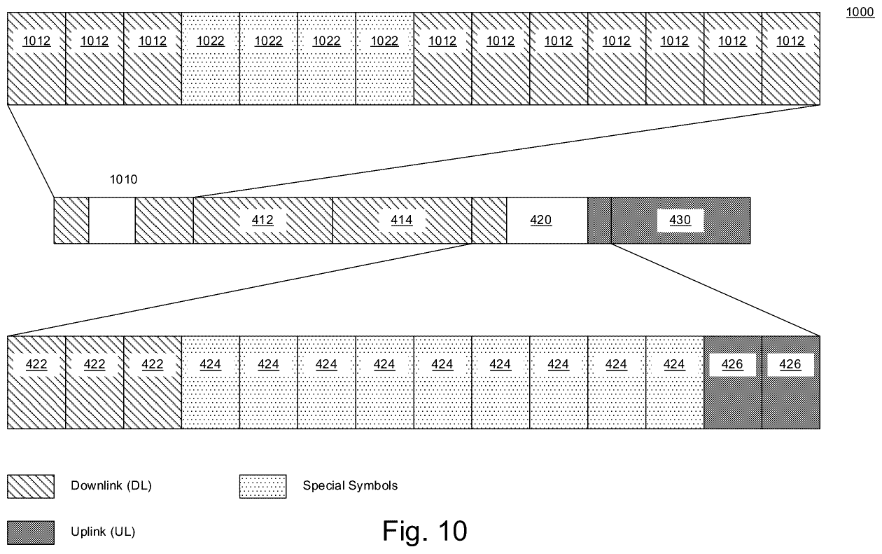

FIG. 10 illustrates a block diagram of an example TDD configuration in accordance with some arrangements. As illustrated by way of example in FIG. 10, an example TDD configuration 1000 can include the downlink slots 410, 412 and 414, the slot 420, the uplink slot 430, and slot 1010. The slot 420 can include the downlink symbols 422, the special symbols 424, and the uplink symbols 426. The slot 1010 can include downlink symbols 1012, and special symbols 1022.

First, the symbols in a slot can be configured as DL, UL or flexible via first TDD configuration carried by system information, RRC signaling, MAC CE and/or DCI signaling. The first TDD configuration is indicated by the BS to SN (e.g. SN CU). Further, the symbols configured via first TDD configuration can be re-configured as special symbols via fifth configuration carried by RRC signaling (e.g. in ServingCellConfigCommon or ServingCellConfig), MAC CE and/or DCI signaling (e.g. DCI format 2_0), as shown in Figure below. Further, if indicated by DCI signaling, it can be scrambled by a new SN specific, link specific, service-type specific, or SN logic unit specific RNTI. The fifth TDD configuration can be indicated by the BS to SN (e.g. SN CU).

The fifth TDD configuration can configure one or more information parameters for special symbols. An information parameter that can be configured by the fifth TDD configuration can include a slot index. An information parameter that can be configured by the fifth TDD configuration can include periodicity, including reference sub-carrier spacing. An information parameter that can be configured by the fifth TDD configuration can include an indication of all symbols in a slot are special symbols. An information parameter that can be configured by the fifth TDD configuration can include a start (e.g. start index of special symbols) or a length (e.g. the number of special symbols) associated with one or more symbols. An information parameter that can be configured by the fifth TDD configuration can include a bitmap, e.g. bit=1 indicates the corresponding symbol is a special symbol, bit=0 indicates the corresponding symbol is not a special symbol. An information parameter that can be configured by the fifth TDD configuration can include an index that corresponds a slot format including special symbols. An information parameter that can be configured by the fifth TDD configuration can include a function. The function can include one code-point that indicates one function (e.g. sensing) of special symbols, and other code-point(s) indicates other function(s) (e.g. un-forwarding, LBT, measurement, or switch between DL-UL or beams) of special symbols. One or more of above information can also be indicated in any TDD configuration according to present implementations, e.g. the second TDD configuration, the third TDD configuration.

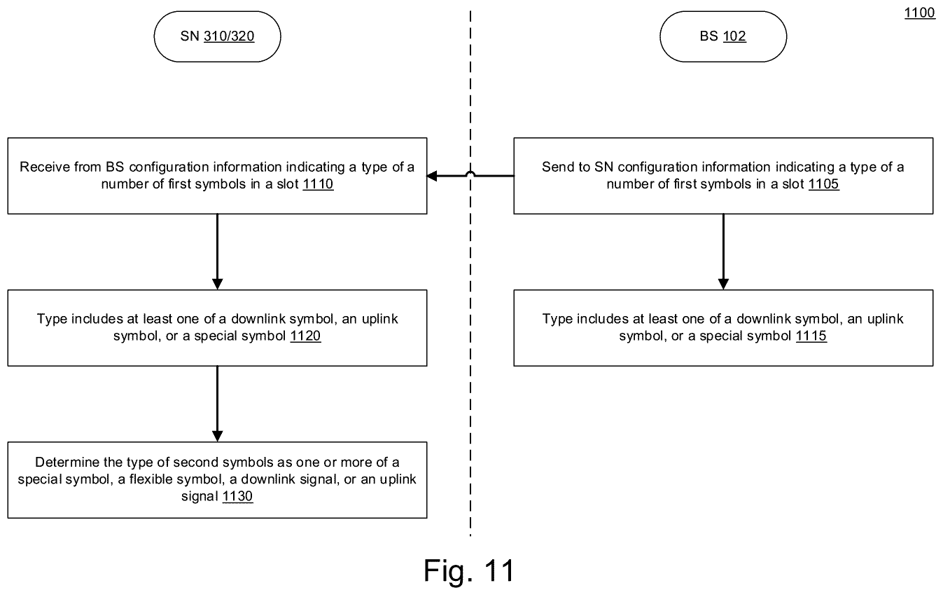

FIG. 11 is a diagram illustrating an example method for slot format configuration for smart nodes in accordance with some arrangements. At least one of the example systems 100 and 200 can perform method 1100 according to present implementations. The method 1100 can begin at 1105.

At 1105, the method can send to an SN configuration information indicating a type of a number of first symbols in a slot. The method 1100 can then continue to one or more of 1110 and 1115. At 1110, the method can receive from a BS configuration information indicating a type of a number of first symbols in a slot. The method 1100 can then continue to 1120. At 1115, the type can include at least one of a downlink symbol, an uplink symbol, or a special symbol. The method 1100 can end at 1115. At 1120, the type can include at least one of a downlink symbol, an uplink symbol, or a special symbol. The method 1100 can then continue to 1130. At 1130, the method can determine the type of second symbols as one or more of a special symbol, a flexible symbol, a downlink signal, or an uplink signal. The method 1100 can end at 1130.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

1. A wireless communication method, comprising:
receiving, by a network node from a wireless communication node, configuration information indicating a type of a number of first symbols in a slot,
wherein the type includes at least one of: a downlink symbol, an uplink symbol, or a special symbol.

2. The wireless communication method of claim 1, wherein the special symbol can cause the network node to perform at least one of optionally forwarding based on the special symbol, sensing based on the special symbol, switching between DL and UL based on the special symbol, beam switching based on the special symbol, switching between ON and OFF states based on the special symbol, or be turned OFF based on the special symbol.

3. The wireless communication method of claim 1, further comprising:
receiving, by the network node, the configuration information from the wireless communication node through a signaling,
wherein the signaling comprises at least one of: system information, a Radio Resource Control (RRC) signaling, a medium access control control element (MAC CE) signaling, or a Downlink Control Information (DCI) signaling.

4. The wireless communication method of claim 1, wherein the configuration information does not indicate a type of a number of second symbols in the slot as the downlink symbol or the uplink symbol.

5. The wireless communication method of claim 4, further comprising:
determining, by the network node, the type of the second symbols as the special symbol.

6. The wireless communication method of claim 4, further comprising:
determining, by the network node, the type of the second symbols as a flexible symbol.

7. The wireless communication method of claim 6, wherein the type of some or all of the second symbols is configured as the special symbol.

8. The wireless communication method of claim 6, wherein the type of all of the second symbols is the special symbol.

9. The wireless communication method of claim 6, wherein the type of some of the second symbols is configured as the special symbol, and the type of some of the second symbols is configured as one of the downlink symbol, the uplink symbol, an ON state, or an OFF state.

10. The wireless communication method of claim 6, wherein the type of some of the second symbols is configured as the special symbol, and the type of one or more remaining ones of the second symbols is the downlink symbol or the uplink symbol by default.

11. The wireless communication method of claim 1, wherein the configuration information indicates a type of each symbol in the slot as one of the downlink symbol, the uplink symbol, or the special symbol.

12. The wireless communication method of claim 1, wherein the configuration information does not indicate a type of a number of second symbols in the slot as the downlink symbol, the uplink symbol, or the special symbol.

13. The wireless communication method of claim 12, further comprising:
determining, by the network node, the type of the second symbols as a flexible symbol.

14. The wireless communication method of claim 12, further comprising:
determining, by the network node, the type of the second symbols as either the downlink symbol or the uplink symbol.

15. The wireless communication method of claim 12, wherein the configuration information indicates the type of the first symbols in the slot as the special symbol and indicates that the second symbols are before the first symbols, and the wireless communication method further comprises:
determining, by the network node, the type of the second symbols as the downlink symbol.

16. The wireless communication method of claim 12, wherein the configuration information indicates the type of the first symbols in the slot as the special symbol and indicates that the second symbols are after the first symbols, and the wireless communication method further comprises:
determining, by the network node, the type of the second symbols as the uplink symbol.

17. The wireless communication method of claim 12, wherein the configuration information indicates the type of the first symbols in the slot as the special symbol and indicates that the second symbols are before the first symbols, and the wireless communication method further comprises:
determining, by the network node, the type of the second symbols as the uplink symbol.

18. A network node, comprising:
receive, via a receiver from a wireless communication node, configuration information indicating a type of a number of first symbols in a slot,
wherein the type includes at least one of: a downlink symbol, an uplink symbol, or a special symbol.

19. A wireless communication method, comprising:
sending, by a wireless communication node to a network node, configuration information indicating a type of a number of first symbols in a slot,
wherein the type includes at least one of: a downlink symbol, an uplink symbol, or a special symbol.

20. A wireless communication node, comprising:
at least one processor configured to:
send, via a transmitter to a network node, configuration information indicating a type of a number of first symbols in a slot,
wherein the type includes at least one of: a downlink symbol, an uplink symbol, or a special symbol.
